(19) United States
(12) Patent Application Publication
(10) Pub. No.: US 2024/0165506 A1
(43) Pub. Date: May 23, 2024

(54) Remote Play System for an Arcade Machine

(71) Applicant: Jeremy Alessi, Norfolk, VA (US)

(72) Inventor: Jeremy Alessi, Norfolk, VA (US)

(21) Appl. No.: 18/057,348

(22) Filed: Nov. 21, 2022

(51) Int. Cl. A63F 13/323; A63F 13/355

(52) U.S. Cl. CPC A63F 13/323; A63F 13/355

(57) ABSTRACT

Remote Play System for an Arcade Machine utilizes a novel combination of local arcade infrastructure, RTIS (Real-Time Interactive Streaming) software, server-side infrastructure, and remote client-side infrastructure to cultivate a paradigm-shift for brick-and-mortar arcade operators' businesses.

### CROSS-REFERENCE TO RELATED APPLICATIONS

Provisional Patent Application 63/283,627

### BACKGROUND

The invention will provide a remote play system for an arcade machine, which would permit people not physically located within the confines of the arcade facility's “brick and mortar” location to play on-premises arcade machines.

### PRIOR ART

U.S. Pat. No. 11,130,055—System and method for granting remote access to a video game executed on a video game console or network client
U.S. Pat. No. 11,127,247—System and method for utilizing mobile device to provide inputs in a gaming environment
U.S. Pat. No. 11,123,633—Method and apparatus for controlling game
U.S. Pat. No. 11,083,964—Cloud game streaming with client side asset integration
U.S. Pat. No. 11,074,778—Location based restrictions on networked gaming
U.S. Pat. No. 11,074,580—Device and method for providing external access to multi-drop bus peripheral devices
U.S. Pat. No. 8,568,238—System for remote game access
U.S. Pat. No. 6,406,372—System and method for transferring user-defined instructions between a home video game and an arcade video game

### BRIEF SUMMARY

Arcade machines have included certain elements of online connectivity for the purposes of online multiplayer, software updates, maintenance, and data collection. The introduction of RTIS (Real-Time Interactive Streaming) technology, which has been used in other fields, is novel as applied to off-site arcade patronage.

Arcade-machine patronage is fundamentally limited to foot-traffic and arcades must be open. This limitation restricts arcade owners' revenue-earning potential. Furthermore, as evidenced during the COVID-19 pandemic, lockdowns pose a major risk to the arcade business model. My invention mitigates these risks or limitations.

### DRAWINGS

FIG. 1. A diagram of the invention including components and linkages.

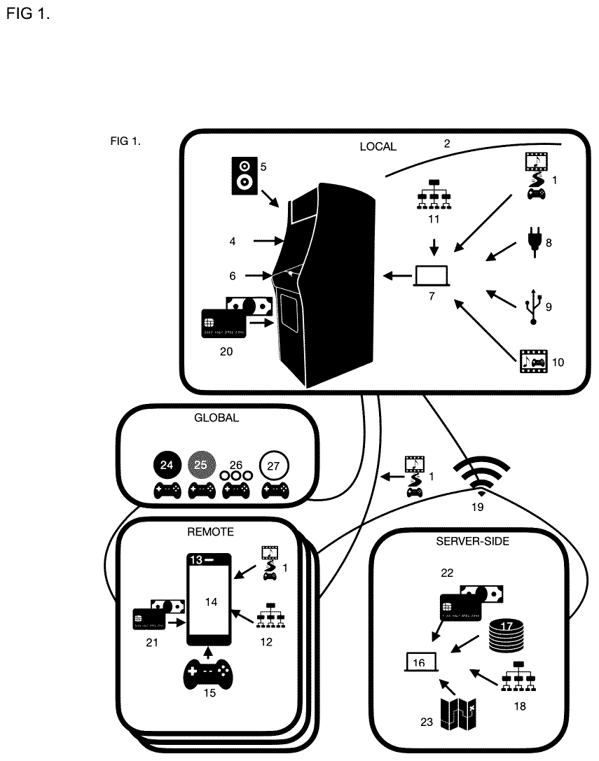

FIG. 2. A diagram of an example global-to-local software-defined input assignment map 28 interface.

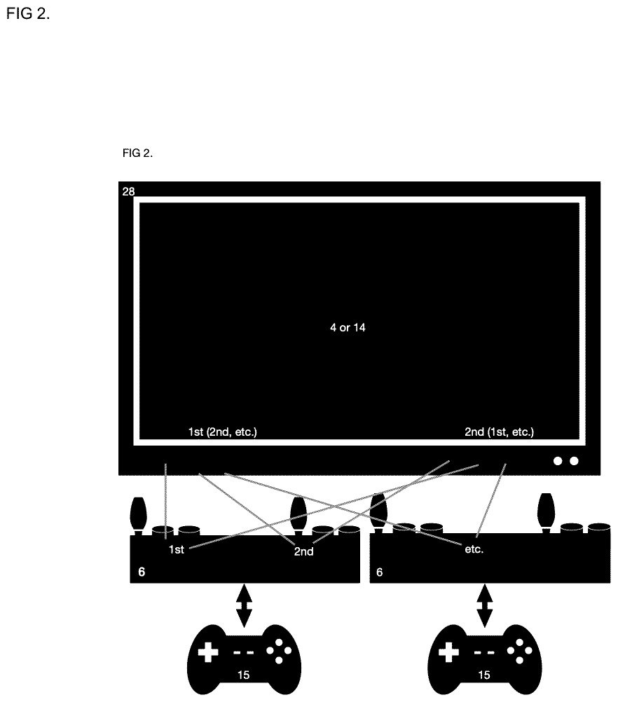

FIG. 3. A diagram demonstrating the connection between local input devices 6, remote input devices 15, the global-to-local software-defined input assignment map 28, the global-to-content software-defined input assignment bridge 31, and the local content-software intended inputs 32.

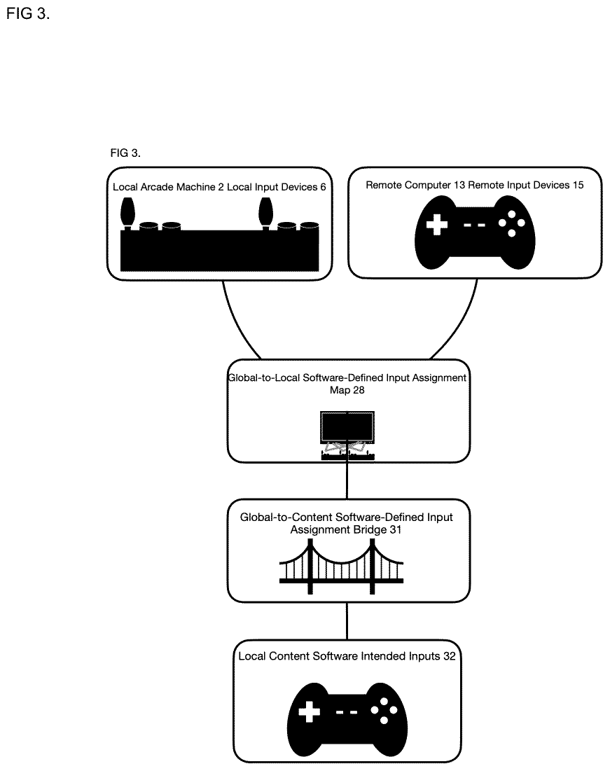

### DETAILED DESCRIPTION

### Components:

1. Real-Time Interactive Streaming Software
2. Local Arcade Machine
3. Local Cabinet
4. Local Display
5. Local Speakers & Amplifier
6. Local Input Devices
7. Local Computer (CPU, GPU, Hard Disk, Memory, Network Card, BIOS, OS, etc)
8. Local Power Supplies
9. Local Internet Connection
10. Local Content Software
11. Local Thin-Client Software
12. Remote Thin-Client Software
13. Remote Computer (CPU, GPU, Hard Disk, Memory, Network Card, BIOS, OS, etc)
14. Remote Display
15. Remote Input Devices
16. Server-Side Computer (CPU, GPU, Hard Disk, Memory, Network Card, BIOS, OS, etc)
17. Server-Side Database
18. Server-Side Software
19. Network Linkage
20. Local Payment-Capture Mechanism
21. Remote Payment-Capture Mechanism
22. Server-Side Payment-Capture Mechanism
23. Server-Side Adjustable Software Algorithm to Determine Payout
24. Global Software-Defined First-Player Slot
25. Global Software-Defined Second-Player Slot
26. Global Software-Defined Sequence of Player Slots
27. Global Software-Defined Maximum Number of Player Slots
28. Global-to-Local Software-Defined Input Assignment Map
29. Global Software-Defined Maximum Number of Local and Remote Thin-Client Instances
30. Global Software-Defined Disconnect Input Devices Mechanism
31. Global-to-Content Software-Defined Input Assignment Bridge
32. Local Content-Software Intended Inputs

### DESCRIPTION

The method or arrangement of wiring or connecting the listed components to achieve the listed description will be well-known to those with ordinary skill levels in the arcade-hardware and game-development arts.
Real-time interactive streaming software 1 (which shall mean software with the capability to transmit audio and video signals extracted from local content software 10 and transmit input signals from local input devices 6 or remote input devices 15) to be injected into local content software 10, to the local computer 7 or to remote computers 13 over a network including the Internet with sub-300 millisecond latency. Real-time interactive streaming software 1 shall also synchronize a global software-defined first-player slot 24, a global software-defined second-player slot 25, a global software-defined sequence of player slots 26, a global software-defined maximum number of player slots 27, a global-to-local software-defined input assignment map 28, a global software-defined maximum number of local and remote thin-client instances 29, a global software-defined disconnect input devices mechanism 30, and a global-to-content software-defined input assignment bridge 31.
A local arcade machine 2 comprised of local cabinet 3, local display 4, local speakers & amplifier 5, local input devices 6, local computer 7, local power supplies 8, local Internet connection 9, real-time interactive streaming software 1, and local content software 10. If needed, the arcade machine may also run in parallel, local thin-client software 11. Arcade machine play can be accessed directly from local content software 10 or via a local thin-client software 11.
At least one, remote thin-client software 12 or local thin-client software 11 (up to a global software-defined maximum number of local and remote thin-client instances 29) featuring real-time interactive streaming software 1 running on the local computer 7 (using local input devices 6) or on a remote computer 13 (using remote input devices 15) capable of communicating with local arcade machine 2 local content software 10 via real-time interactive streaming software 1.
A server-side computer 16, server-side database 17, and server-side software 18 to establish network linkage 19 to one or more local arcade machines 2, up to global software-defined-maximum number of local and remote thin-client instances 29 per local arcade machine 2.
A global-to-local software-defined input assignment map 28 that connects global software-defined sequence of player slots 26 to local input devices 6 and remote input devices 15 as well as a global-to-content software-defined input assignment bridge 31 that connects the global-to-local software-defined input assignment map 28 to local content-software intended inputs 32.
If needed, local payment-capture mechanism 20 can be appended to local arcade machine 2.
If needed, remote payment-capture mechanism 21 can be appended to remote computer 13.
If needed, server-side payment-capture mechanism 22 can be appended to server-side computer 16.
If needed, a server-side adjustable software algorithm to determine payout 23 running on server-side computer 16 within server-side software 18 that can split payment between multiple parties (local arcade game 2 operator, server-side computer 16 host, remote thin-client software 12 provider, etc.)

### Operation:

Configure local computer 7 to boot up upon power engagement to automatically run real-time interactive streaming software 1, local content software 10, and local thin-client software 11. Enable local power supplies 8. These disparate software components are synchronized to provide a traditional arcade experience whereby the local content software 10 becomes accessible just by powering on the local arcade machine 2.
Physically approach local arcade game 2, if needed, engage local payment-capture mechanism 20. Start playing with any of local input devices 6. Whichever of local input devices 6 was first engaged, becomes global software-defined first-player slot 24.
Access remote thin-client software 12 from a remote computer 13 with remote input devices 15 (if needed, engage remote payment-capture mechanism 21). Begin playing local content software 10 installed on local arcade machine 2 remotely via real-time interactive streaming software 1. This process can be repeated to connect additional remote thin-client software 12 instances up to global software-defined maximum number of local and remote thin-client instances 29.
If local input devices 6 or remote input devices 15 occupy the global software-defined first-player slot 24 stored in local computer 7 memory of real-time interactive streaming software 1 via global-to-local software-defined input assignment map 28 and in local content software 10 via global-to-content software-defined input assignment bridge 31, the next player to press a button on either local input devices 6 or remote input devices 15 will then occupy the global software-defined second-player slot 25. This process will continue through global software-defined sequence of player slots 26 until the global software-defined maximum number of player slots 27 has been reached. Players can keep track of their local content software 10 interaction via the global-to-local software-defined input assignment map 28 interface.
If needed, engage server-side payment-capture mechanism 22 to calculate and arrange payment between multiple parties.
At any point during operation, the global software-defined disconnect input devices mechanism 30 can be triggered by user input from local input devices 6 or remote input devices 15 to reset the global-to-local software-defined input assignment map 28.
At any point during operation, local input devices 6 or remote input devices 15 can be used to cycle through and load from a library of local content software 10.
At any point during operation, local input devices 6 or remote input devices 15 can be used to save or load from a specified point within local content software 10.
At any point during operation, local input devices 6 or remote input devices 15 can be used to adjust the quality of audio or video capture of local content software 10 to remote thin-client software 12 or to local thin-client software 11.

### Alternative Embodiments

There are many alternative ways in which my invention, Remote Play System for an Arcade Machine, could be used.
It could be used with gambling machines instead of a local arcade machine 2.
The local display 4 could be a traditional monitor, a head-mounted display, a projector, or any other means of displaying output to users of local arcade machine 2.
The remote display 14 could be a traditional monitor, a head-mounted display, a projector, or any other means of displaying output to users of remote thing-client software 12 running on remote computer 13.
Local arcade machine 2 could be replaced with a home user's (as opposed to an arcade operator's) local computer 7.
The local or remote aspect of local arcade machine 2 could be enabled or disabled to varying degrees to cultivate certain experiences or create varying degrees of exclusivity.
Local content software 10 could be a video, music, an application, or other media instead of a traditional arcade video game.
The local payment capture mechanism 20, remote payment-capture mechanism 21, and server-side payment-capture mechanism 22 could be represented in various ways, such as coin slots, card readers, or an online account system tied to a credit card, bank account, or other financial backing.
The global-to-local software-defined input assignment map 28 can be represented by numerous text and/or graphics layouts to communicate to users which local input devices 6 or remote input devices 15 align with local display 4 or remote display 14 relative representation (game character, mouse cursor, virtual laser pointer, etc.).

These various layouts could appear either via the local arcade machine 2 local display 4 and the local content software 10 and/or the local thin-client software 11. They may also appear via the remote computer 13 remote display 14 and/or the remote thin-client software 12.

What is claimed is:

1. A local arcade machine having real-time interactive streaming software for enabling remote play, comprising:
a local cabinet having a local display, local speakers & amplifier, local input devices, local computer, and local power supplies contained within it and/or mounted to it;
a local computer contained within local cabinet, having local Internet connection, local content software, and local thin-client software having network linkage to a remote computer and server-side computer and local payment-capture mechanism;
a local payment-capture mechanism having network linkage to local computer;
a remote computer, having remote display, remote input devices, remote payment capture mechanism and remote thin-client software having network linkage to local computer and server-side computer and remote payment-capture mechanism;
a server-side computer, having server-side database, server-side payment-capture mechanism, server-side adjustable software algorithm to determine payout, and server-side software having server-side payment capture mechanism and network linkage to local computer and remote computer.

2. A local arcade machine having real-time interactive streaming software according to claim 1, wherein the real-time interactive streaming software comprises a global software-defined first-player slot.

3. A local arcade machine having real-time interactive streaming software according to claim 1, wherein the real-time interactive streaming software comprises a global software-defined second-player slot.

4. A local arcade machine having real-time interactive streaming software according to claim 1, wherein the real-time interactive streaming software comprises a global software-defined sequence of player slots.

5. A local arcade machine having real-time interactive streaming software according to claim 1, wherein the real-time interactive streaming software comprises a global software-defined maximum. number of player slots.

6. A local arcade machine having real-time interactive streaming software according to claim 1, wherein the real-time interactive streaming software comprises a global-to-local software-defined input assignment map.

7. A local arcade machine having real-time interactive streaming software according to claim 1, wherein the real-time interactive streaming software comprises a global software-defined maximum number of local and remote thin-client instances.

8. A local arcade machine having real-time interactive streaming software according to claim 1, wherein the real-time interactive streaming software comprises a global software-defined disconnect input devices mechanism.

9. A local arcade machine having real-time interactive streaming software according to claim 1, wherein the real-time interactive streaming software comprises a global-to-content software-defined input assignment bridge.

10. A local arcade machine having real-time interactive streaming software according to claim 1, wherein the real-time interactive streaming software comprises a local content-software intended inputs.
